(19) United States
(12) Patent Application Publication
(10) Pub. No.: US 2015/0086192 A1
(43) Pub. Date: Mar. 26, 2015

(54) DETERMINING METHOD, DETERMINING OPTICAL MODULE, AND OPTICAL COMMUNICATION APPARATUS

(71) Applicant: FUJITSU LIMITED, Kawasaki-shi (JP)

(72) Inventor: Takeshi SAKAMOTO, Kawasaki (JP)

(73) Assignee: FUJITSU LIMITED, Kawasaki-shi (JP)

(21) Appl. No.: 14/560,500

(22) Filed: Dec. 4, 2014

Related U.S. Application Data
(63) Continuation of application No. PCT/JP2012/064692, filed on Jun. 7, 2012.

(51) Int. Cl. H04B 10/077; H04J 14/02

(52) U.S. Cl. CPC H04B 10/0775; H04J 14/0202
USPC 398/16

(57) ABSTRACT

In order to determine a connection state of an optical fiber that connects a transmitting terminal and a plurality of receiving terminals, a test signal having a wavelength corresponding to a wavelength of an optical signal capable of being received at one receiving terminal among the plurality of receiving terminals is generated by clipping a portion of amplified spontaneous emission light. The generated test signal is transmitted through the optical fiber. Optical power of the test signal is detected at the one receiving terminal. The connection state of the optical fiber is determined based on a detection result of the optical power of the test signal.

### CROSS-REFERENCE TO RELATED APPLICATION

This application is a continuation application of International Application PCT/JP2012/064692, filed on Jun. 7, 2012 and designated the U.S., the entire contents of which are incorporated herein by reference.

### FIELD

The present invention relates to a determining method, a determining optical module, and an optical communication apparatus.

### BACKGROUND

Recently, with the increase of communication demand due to the spread of the Internet, a wavelength division multiplexing (WDM) system using a broadband property of an optical amplifier has become popular.

In the WDM system, all or part of optical nodes include an optical add-drop multiplexer (OADM). The OADM can add an optical signal to an optical communication channel in wavelength unit and can drop an optical signal from an optical communication channel in wavelength unit.

That is, the OADM has a function (optical add function) of adding an optical signal having a certain wavelength to a WDM optical signal and a function (optical drop function) of dropping an optical signal having a certain wavelength from a WDM optical signal. The OADM that adds and/or drops an optical signal having a certain wavelength may be called a reconfigurable OADM (ROADM).

Herein, it is preferable that the OADM has a color less, directionless, and contentionless (CDC) function such that a wavelength path can be flexibly set or changed.

Color less refers to a configuration or a function that can input an arbitrary wavelength to an arbitrary port of the OADM and can output an arbitrary wavelength from an arbitrary port. Also, directionless refers to a configuration or a function that, when the OADM is configured to have a plurality of routes, can guide an optical signal from each terminal station to an arbitrary route and can guide an optical signal from each route to an arbitrary terminal station. Furthermore, contentionless refers to a configuration or a function that avoids collision of optical signals having the same wavelength in the OADM.

An example of an OADM having a CDC function is described in Patent Literature 1 (Japanese Laid-open Patent Publication No. 2012-015726).

### SUMMARY

(1) According to the first aspect, there is provided a determining method for determining a connection state of an optical fiber that connects a transmitting terminal and a plurality of receiving terminals, the determining method including: generating a test signal having a wavelength corresponding to a wavelength of an optical signal capable of being received at one receiving terminal among the plurality of receiving terminals by clipping a portion of amplified spontaneous emission light; transmitting the generated test signal through the optical fiber; detecting optical power of the test signal at the one receiving terminal; and determining the connection state of the optical fiber based on a detection result of the optical power of the test signal.

(2) According to the second aspect, there is provided a determining optical module for determining a connection state of an optical fiber that connects a transmitting terminal and a plurality of receiving terminals, the determining optical module including: a wavelength tunable filter configured to generate a test signal having a wavelength corresponding to a wavelength of an optical signal capable of being received at one receiving terminal among the plurality of receiving terminals by clipping a portion of amplified spontaneous emission light; and an optical output interface configured to output the test signal generated by the wavelength tunable filter.

(3) According to the third aspect, there is provided an optical communication apparatus including: a plurality of optical modules; an optical fiber configured to connect the plurality of optical modules; the determining optical module according to the above (2); a photo detector configured to detect the optical power of the test signal output from the determining optical module at the one receiving terminal; and a processor configured to determine the connection state of the optical fiber based on a detection result of the photo detector.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIGS. 1A and 1B are diagrams that illustrate examples of a configuration of an optical system.

FIG. 2 is a diagram that illustrates an example of a configuration of an optical communication apparatus.

FIG. 3 is a diagram that illustrates an example of a configuration of an optical module according to an embodiment.

FIG. 4A is a diagram that illustrates an example of ASE light, and FIG. 4B is a diagram that illustrates an example of a test signal.

FIG. 5 is a diagram that illustrates an example of a determining method according to an embodiment.

FIG. 6 is a diagram that illustrates an example of a configuration of an optical module according to a first modification.

FIG. 7 is a diagram that illustrates an example of a configuration of an optical module according to a second modification.

FIG. 8 is a diagram that illustrates an example of a configuration of an optical communication apparatus according to a third modification.

FIG. 9 is a diagram that illustrates an example of a configuration of an optical communication apparatus according to a fourth modification.

FIG. 10 is a diagram that illustrates an example of a configuration of an optical module according to a fifth modification.

FIG. 11A is a diagram that illustrates an example of ASE light, FIG. 11B is a diagram that illustrates an example of an optical signal clipped by a TF, and FIG. 11C is a diagram that illustrates an example of a test signal.

FIG. 12 is a diagram that illustrates an example of another configuration of the optical module according to the fifth modification.

FIG. 13 is a diagram that illustrates an example of another configuration of the optical module according to the fifth modification.

FIG. 14A is a diagram that illustrates an example of ASE light, FIG. 14B is a diagram that illustrates an example of a test signal, and FIG. 14C is a diagram that illustrates an example of a detection result at a PD.

FIG. 15 is a diagram that illustrates an example of another configuration of an optical module according to an embodiment.

### DESCRIPTION OF THE PREFERRED EMBODIMENTS

An optical communication apparatus with an OADM includes a plurality of optical devices so as to enhance modularity. Also, the plurality of optical devices is mutually connected by optical fibers. The respective optical devices can receive light of different wavelengths.

In a case where the optical fiber is incorrectly connected, the optical communication apparatus does not normally operate, and thus, it is necessary to check whether all the optical devices are correctly connected to one another. However, with respect to each of the optical devices to be inspected, it is necessary to adapt a wavelength of light to be used for inspection to each optical device, and there is a problem that has much effort and time so as to check and determine that all the optical devices are normally operated.

Hereinafter, embodiments of the present disclosure will be described with reference to the drawings. However, the following embodiments are merely exemplary and are not intended to exclude various modifications or technical applications that are not specified in the following embodiments and modifications. That is, it is apparent that the following embodiments and modifications can be variously changed and modified by, for example, combinations thereof without departing from the scope of the present disclosure.

[1] Regarding Embodiment

(1.1) Example of Configuration of Optical System

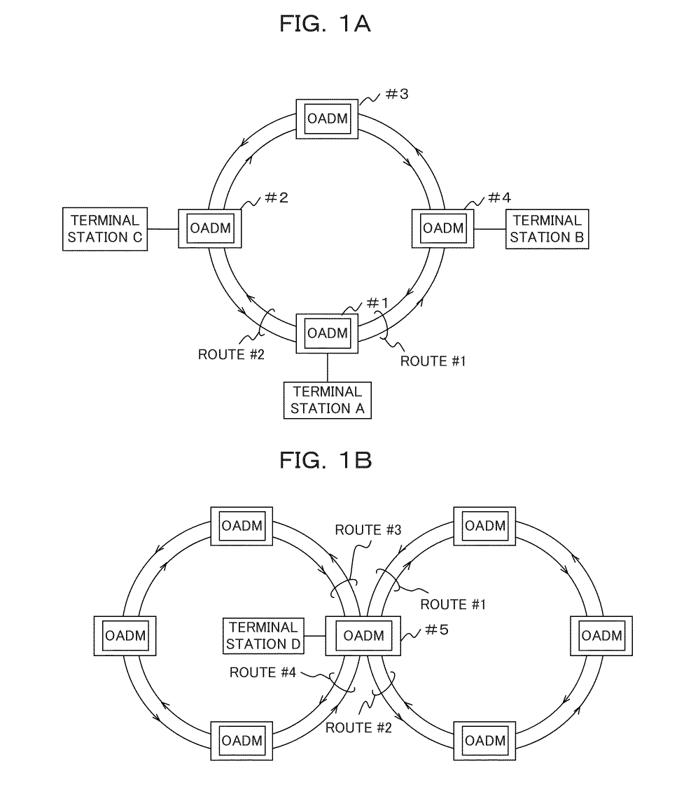

FIGS. 1A and 1B are diagram that illustrate examples of a configuration of an optical system according to an embodiment. An optical add-drop multiplexer (OADM), which is an example of an optical communication apparatus, is provided in an optical node. Also, the OADM has a function of adding an optical signal having one or more certain wavelengths to a WDM optical signal and a function of dropping an optical signal having one or more certain wavelengths from a WDM optical signal. The OADM is also referred to as an optical module or an optical package.

The optical system illustrated in FIG. 1A is a bidirectional ring network and includes four optical nodes #1 to #4. That is, the respective optical nodes are connected through a set of a clockwise optical communication channel and a counterclockwise optical communication channel. Each of the clockwise optical communication channel and the counterclockwise optical communication channel carries a WDM signal. Each of the optical nodes #1 to #4 includes an OADM.

Optical communication channels extending in a certain direction with reference to each optical node or each OADM are referred to as a “route”. For example, the optical node #1 (or, the OADM of the optical node #1) has a route #1 and a route #2. The route #1 is connected to the optical node #4. In the route #1, an optical communication channel (input route) configured to carry a WDM optical signal from the optical node #4 to the optical node #1 and an optical communication channel (output route) configured to carry a WDM optical signal from the optical node #1 to the optical node #4 are set. Also, the route #2 is connected to the optical node #2. In the route #2, an optical communication channel (input route) configured to carry a WDM optical signal from the optical node #2 to the optical node #1 and an optical communication channel (output route) configured to carry a WDM optical signal from the optical node #1 to the optical node #2 are set.

In the optical system configured as above, for example, when data is transmitted from a terminal station A to a terminal station B, the optical node #1 outputs an optical signal transmitted from the terminal station A to the route #1. In this case, the terminal station A transmits an optical signal that carries data by using, for example, a wavelength λ1. Then, the OADM of the optical node #1 adds the optical signal transmitted from the terminal station A to a WDM optical signal carried from the optical node #2 to the optical node #4 through the routes #2 and #1. The OADM of the optical node #4 drops the optical signal having the wavelength λ1 from the WDM optical signal and guides the dropped optical signal to the terminal station B. In this manner, the data transmitted from the terminal station A is received by the terminal station B.

When data is transmitted from a terminal station C to the terminal station A, the terminal station C transmits an optical signal that carries data by using, for example, a wavelength λ2. Then, the OADM of the optical node #2 adds the optical signal transmitted from the terminal station C to a WDM optical signal carried from the optical node #3 to the optical node #1 through the optical node #2 and the route #2. The WDM optical signal is input from the route #2 to the optical node #1. The OADM of the optical node #1 drops the optical signal having the wavelength λ2 from the WDM optical signal and guides the dropped optical signal to the terminal station A. In this manner, the data transmitted from the terminal station C is received by the terminal station A.

In the optical system illustrated in FIG. 1A, each of the OADMs has two routes but may have more routes. For example, in the optical system illustrated in FIG. 1B, an OADM of an optical node #5 has four routes #1 to #4. In this case, the OADM of the optical node #5 may output an optical signal having an arbitrary wavelength transmitted from a terminal station D to an arbitrary route. Also, the OADM of the optical node #5 may drop an optical signal having an arbitrary wavelength from an arbitrary route and transfer the dropped optical signal to the terminal station D.

The number of the routes provided in the OADM is counted by “degree”. For example, since each of the OADMs illustrated in FIG. 1A has two routes, it is called 2-degree. Also, since the OADM of the optical node #5 illustrated in FIG. 1B has four routes, it is called 4-degree.

(1.2) Example of Configuration of Optical Communication Apparatus (OADM)

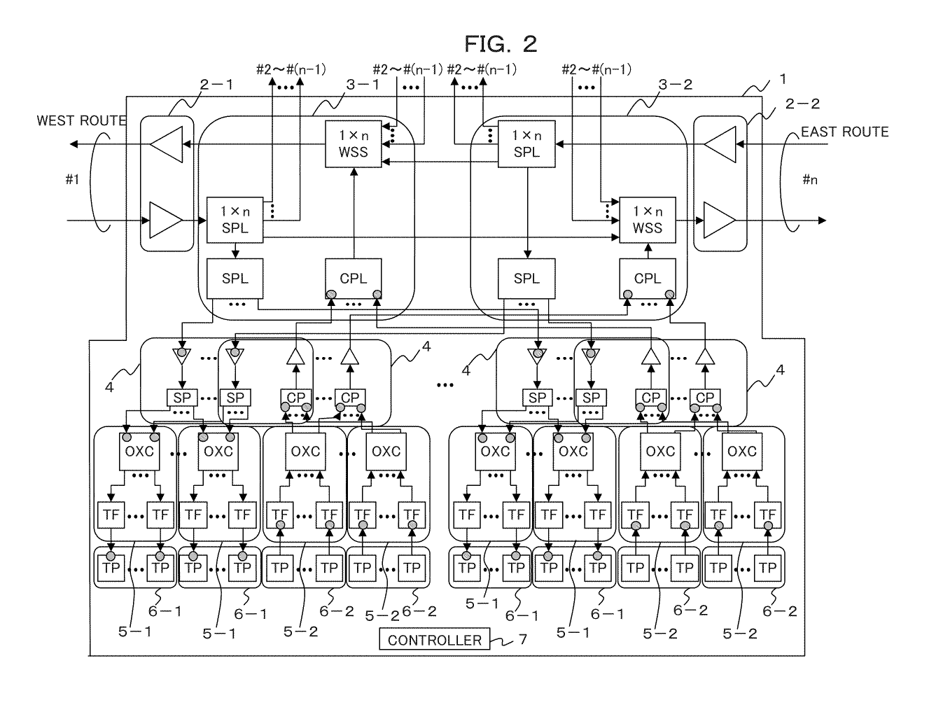

FIG. 2 is a diagram that illustrates an example of a configuration of an optical communication apparatus. In the following, the optical communication apparatus is also referred to as an OADM.

The OADM 1 illustrated in FIG. 2 has, for example, n routes (where n represents an integer equal to or greater than 2). The n routes have, for example, two routes (west route (#1) and east route (#n)) and a plurality of other routes (#2 to #(n−1)). Each of the routes includes a set of an input route and an output route.

The OADM 1 illustrated in FIG. 2 includes, for example, optical modules (packages) 2-1, 2-2, 3-1, 3-2, 4, 5-1, 5-2, 6-1, and 6-2, each of which corresponds to a functional block including a plurality of optical devices (optical elements), and a controller (processor) 7 that controls the respective optical modules 2-1, 2-2, 3-1, 3-2, 4, 5-1, 5-2, 6-1, and 6-2.

Each of the optical modules 2-1 and 2-2 includes a plurality of optical amplifiers. Also, each of the optical modules 3-1 and 3-2 includes a 1×n wavelength selective switch (WSS), a 1×n optical splitter (SPL), an optical splitter (SPL), and an optical coupler (CPL). Furthermore, each of the optical modules 4 includes a plurality of optical amplifiers and a set of an SPL and a CPL. Also, each of the optical modules 5-1 and 5-2 includes an optical cross connect switch (OXC) and a plurality of wavelength tunable filters (TFs). Furthermore, each of the optical modules 6-1 and 6-2 includes a plurality of transponders (TPs). In the following, each of the optical modules 2-1 and 2-2 may be simply referred to as an optical module 2, and each of the optical modules 3-1 and 3-2 may be simply referred to as an optical module 3. Similarly, each of the optical modules 5-1 and 5-2 may be simply referred to as an optical module 5, and each of the optical modules 6-1 and 6-2 may be simply referred to as an optical module 6.

The optical module 2-1 amplifies a WDM optical signal input from the west route and amplifies a WDM optical signal output to the west route. Similarly, the optical module 2-2 amplifies a WDM optical signal input from the east route and amplifies a WDM optical signal output to the east route. A gain of each of the optical amplifiers in the optical modules 2-1 and 2-2 may be calculated in advance and may be dynamically controlled by the controller 7 or the like.

First, when focusing on the drop function of the OADM 1, the 1×n SPL of the optical module 3-1 connected to the optical module 2-1 drops a WDM optical signal input from the west route and guides the dropped WDM optical signal to the 1×n WSS of the optical module 3-2, the SPL of the optical module 3-1, and a plurality of other routes. Similarly, the 1×n SPL of the optical module 3-2 connected to the optical module 2-2 drops a WDM optical signal input from the east route and guides the dropped WDM optical signal to the 1×n WSS of the optical module 3-1, the SPL of the optical module 3-2, and a plurality of other routes.

The SPL of the optical module 3-1 drops a WDM optical signal guided by the 1×n SPL of the optical module 3-1 and guides the dropped WDM optical signal to the optical amplifier of the optical module 4. Similarly, the SPL of the optical module 3-2 drops a WDM optical signal guided by the 1×n SPL of the optical module 3-2 and guides the dropped WDM optical signal to the optical amplifier of the optical module 4.

The optical amplifier of the optical module 4 amplifies an optical signal input from the SPL of the optical module 3-1 and outputs the amplified optical signal to the SPL of the optical module 4. Similarly, the optical amplifier of another optical module 4 amplifies an optical signal input from the SPL of the optical module 3 and outputs the amplified optical signal to the SPL of the optical module 4. A gain of each of the optical amplifiers in the optical modules 4 may be calculated in advance and may be dynamically controlled by the controller 7 or the like.

The SPL of the optical module 4 drops an optical signal amplified by the optical amplifier of the optical module 4 and guides the dropped optical signal to the OXC of the optical module 5-1.

The OXC of each of the optical modules 5-1 guides an input optical signal to an output port, for example, designated by the controller 7. Also, the TF of each of the optical modules 5-1 passes only an optical signal having a wavelength, for example, designated by the controller 7 and blocks optical signals having the other wavelengths, among optical signals input from the OXC.

The TP of the optical module 6-1 transfers the optical signal input from the TF of the optical module 5-1 to a correspondent terminal station. Wavelengths of optical signals output from the TPs of the optical modules 6-1 may be equal to one another or may be different from one another.

Next, when focusing on the add function of the OADM 1, the TPs of the optical modules 6-2 transfer the optical signals transmitted from the correspondent terminal stations to the TFs of the optical modules 5-2, respectively. Wavelengths of the optical signals transmitted from the respective terminal stations may be equal to one another or may be different from one another. Also, wavelengths of the optical signals output from the TPs of the optical modules 6-2 are not specially limited, but may be different from one another.

The TF of each of the optical modules 5-2 passes only an optical signal having a wavelength, for example, designated by the controller 7 and blocks optical signals having the other wavelengths, among optical signals input from the TP of each of the optical modules 6-2. Also, the OXCs of the optical modules 5-2 guide optical signals input from the TFs to output ports, for example, designated by the controller 7.

Also, the CPLs of the optical modules 4 multiplex the optical signals input from the OXCs of the optical modules 5-2 and outputs the multiplexed optical signals. Furthermore, the optical amplifiers of the optical modules 4 amplify the optical signals input from the CPLs and outputs the amplified optical signals. A gain of each of the optical amplifiers in the optical modules 4 may be calculated in advance and may be dynamically controlled by the controller 7 or the like.

The CPL of the optical module 3-1 multiplexes the optical signals input from the optical modules 4 and outputs the multiplexed optical signal to the 1×n WSS of the optical module 3-1. Similarly, the CPL of the optical module 3-2 multiplexes the optical signals input from the optical modules 4 and outputs the multiplexed optical signal to the 1×n WSS of the optical module 3-2.

The 1×n WSS of the optical module 3-1 generates a WDM optical signal to be output to the west route, from the optical signal guided from the east route through the 1×n SPL of the optical module 3-2, the optical signal guided from the CPL of the optical module 3-1, and the optical signals input from the plurality of other routes, for example, under the control of the controller 7. In this case, the 1×n WSS of the optical module 3-1 selects one or more arbitrary wavelengths “passing through” the OADM 1 from the optical signal guided from the east route through the 1×n SPL of the optical module 3-2 and the optical signals input from the plurality of other routes. Also, the 1×n WSS of the optical module 3-1 selects one or more arbitrary wavelengths to be “added” to a WDM optical signal from the optical signal guided from the CPL of the optical module 3-1.

Similarly, the 1×n WSS of the optical module 3-2 generates a WDM optical signal to be output to the east route, from the optical signal guided from the west route through the 1×n SPL of the optical module 3-1, the optical signal guided from the CPL of the optical module 3-2, and the optical signals input from the plurality of other routes, for example, under the control of the controller 7. In this case, the 1×n WSS of the optical module 3-2 selects one or more arbitrary wavelengths “passing through” the OADM 1, from the optical signal guided from the west route through the 1×n SPL of the optical module 3-1 and the optical signals input from the plurality of other routes. Also, the 1×n WSS of the optical module 3-2 selects one or more arbitrary wavelengths to be “added” to a WDM optical signal from the optical signal guided from the CPL of the optical module 3-2.

The controller 7 controls the respective optical modules 2 to 6 according to an instruction from a user or a network manager (not illustrated). For this reason, the controller 7 includes, for example, a processor and a memory. The memory may store a program in which the add operation and the drop operation of the OADM 1 are described. In this case, the processor provides the optical signal add operation and the optical signal drop operation by executing the program stored in the memory. Also, the controller 7 may provide an interface between the OADM 1 and a user or a network manager.

(1.3) Regarding Method for Determining Connection State of Optical Fiber

Herein, an example of a method (determining method) for determining whether or not an optical fiber connecting the optical modules 2 to 6 of the OADM 1 illustrated in FIG. 2 is correctly connected will be described.

As an example of the determining method, there is a method that modulates optical signals in different frequencies for respective connection destinations of optical fibers in an optical signal transmission source and detects the modulated optical signals by optical detectors (PDs) (photo diodes) disposed at respective connection destinations of the optical fibers.

This method can detect the optical signals, on which a modulation process is performed in different frequencies, by the optical detectors (PDs) disposed at respective connection destinations of the optical fibers, and check whether or not the optical signals are correctly transmitted from a certain transmission source by detecting modulation frequencies of the received optical signals, based on the detection results. In the above method, it is preferable that the modulation performed on each optical signal is moderate enough not to affect data superimposed on each optical signal.

However, generally, the number of optical fiber connections is significantly large in the OADM 1 having a CDC function. For example, in a case where the OADM 1 has 8-degree and can transmit and receive 88-wave optical signals, there is a possibility that several hundreds to several thousands of optical fibers will be used. Therefore, when the above-described method is applied to the OADM 1 such that modulators are disposed at all connection sources of the optical fibers and optical detectors are disposed at all connection destinations of the optical fibers, the size and the manufacturing cost of the OADM 1 are increased.

Also, in a case where the routes of the respective optical signals are incorrectly connected in the OADM 1 having the CDC function, there is a possibility that collision of wavelengths will occur, an error will occur in the existing optical signal, and the optical signal will be transmitted to an incorrect route. Therefore, when the above-described method is applied to the OADM 1, the number of the modulation frequencies corresponding to the number of the connections of the optical fibers is used. As the number of the modulation frequencies are becomes larger, an optical detector (PD) with higher sensitivity is required, leading to an increase in the size and the manufacturing cost of the OADM 1.

In the present example, there is proposed a method that easily determines a connection state of an optical fiber.

For example, a test signal for determining a connection state of an optical fiber is generated by clipping a portion of amplified spontaneous emission (ASE) light emitted from the optical amplifier of the OADM 1, and it is determined whether or not the test signal is correctly detected at a receiving terminal (connection destination) by guiding the generated test signal to the optical fiber that connects optical modules. In this manner, the connection state of the optical fiber is determined. It is apparent that the present disclosure is not limited to the application to the OADM 1 illustrated in FIG. 2, and can be applied to various optical fiber connection modes.

For example, it is assumed that optical detectors (PD) capable of detecting optical power of input light are disposed at receiving terminals (connection destinations of the optical fibers) of the respective optical modules 3 to 6 of the OADM 1 (see a shaded circle in FIG. 2).

(1.4) Configuration Example of Determining Optical Module According to Embodiment

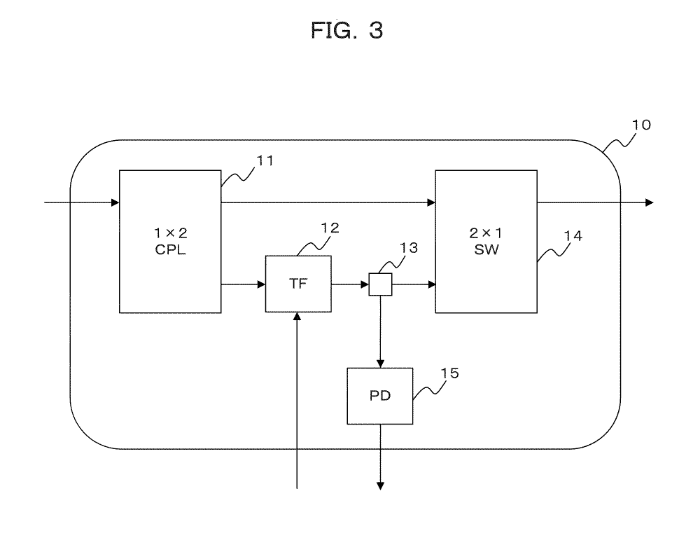

FIG. 3 is a diagram that illustrates an example of a configuration of a determining optical module (hereinafter, simply referred to as an optical module) according to an embodiment.

An optical module 10 illustrated in FIG. 3 includes, for example, a 1×2 optical coupler (CPL) 11, a wavelength tunable filter (TF) 12, a 1×2 optical coupler (CPL) 13, a 2×1 optical switch (SW) 14, and an optical detector (PD) 15.

It is preferable that the optical module 10 is disposed, for example, between the optical amplifier of the optical module 2-1 and the 1×n SPL of the optical module 3-1 or between the optical amplifier of the optical module 2-2 and the 1×n SPL of the optical module 3-2 in the OADM 1 illustrated in FIG. 2. In this case, ASE light emitted from the optical amplifiers of the optical modules 2-1 and 2-2 may be input to the optical module 10. Also, the optical module 10 may be disposed between the optical amplifier of the optical module 4 and the CPL of the optical module 3-1 or between the optical amplifier of the optical module 4 and the CPL of the optical module 3-2.

Herein, the 1×2 CPL 11 drops input light and guides the dropped input light to the 2×1 SW 14 and the TF 12 of the subsequent stage. The input light includes ASE light input from the optical amplifier of the preceding stage and main signal light input during the operation of the optical system.

The TF 12 passes only an optical signal having a certain wavelength and blocks optical signals having the other wavelengths, among optical signals input from the 1×2 CPL 11. The wavelength passed by the TF 12 may be controlled by, for example, the controller 7 or the like.

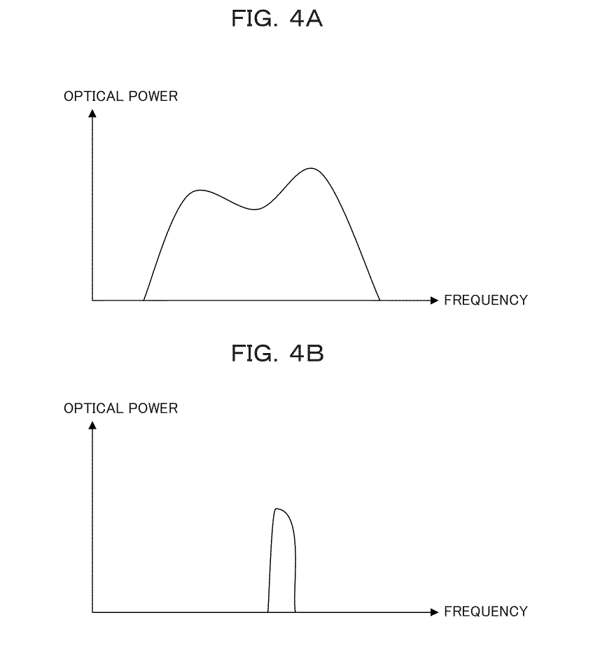

For example, in the process of determining the connection state of the optical fiber, ASE light having a frequency-optical power characteristic illustrated in FIG. 4A is input to the TF 12. In this case, as illustrated in FIG. 4B, the TF 12 generates a test signal for determining the connection state of the optical fiber by clipping a portion of ASE light corresponding to an optical signal, which propagates through the optical system, having a single wavelength. The test signal, which is generated by the TF 12, is output to the 1×2 CPL 13.

That is, the TF 12 functions as an example of a wavelength tunable filter that generates a test signal having a wavelength corresponding to a wavelength of an optical signal capable of being received at a connection destination (receiving terminal) among connection destinations (a plurality of receiving terminals) of the optical fiber by clipping a portion of the input ASE light.

The 1×2 CPL 13 drops the test signal generated by the TF 12 and guides the dropped test signal to the 2×1 SW 14 and the PD 15.

The 2×1 SW 14 selects one of the optical signal input from the 1×2 CPL 11 and the optical signal input from the 1×2 CPL 13 and outputs the selected optical signal. For example, the 2×1 SW 14 selects the optical signal input from the 1×2 CPL 13 (that is, the test signal) at the time of determining the connection state of the optical fiber when the OADM 1 is started up or a new channel is established, and selects the optical signal input from the 1×2 CPL 11 (that is, the main signal light) at the time of actually operating the optical system and the OADM 1. The selecting operation of the 2×1 SW 14 may be controlled by, for example, the controller 7 or the like.

That is, the 2×1 SW 14 functions as an example of an optical output interface that outputs the test signal generated by the TF 12.

Also, the PD 15 detects the optical power of the test signal that is dropped and input by the 1×2 CPL 13. The detection result, for example, is notified to the controller 7 or the like and is used in an amplification gain control for the optical amplifier of the OADM 1, a pass band control of the TF 12, or the like. That is, the optical power of the test signal may be controlled to a certain value.

In the present example, the test signal, which is generated by clipping a portion of the ASE light at the optical module 10 having the above configuration, is detected at the optical detectors (PD) provided at the optical fiber connection terminals of the respective optical modules 2 to 6, and whether or not the respective optical fiber connections are valid is determined based on the detection result.

Hereinafter, an example of the determining method of the present embodiment will be described.

(1.5) Determining Method According to Embodiment

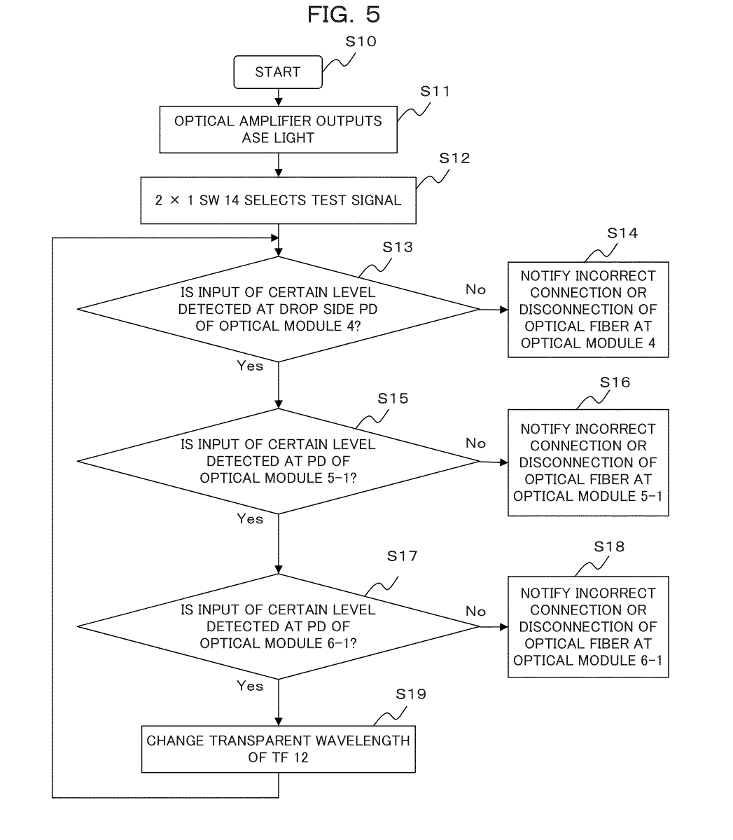

First, as illustrated in FIG. 5, when a process of determining a connection state of an optical fiber is started in response to the start-up of the OADM 1 or the establishment of a new channel (step S10), ASE light is emitted from the optical amplifier of the OADM 1 (step S11).

The 1×2 CPL 11 of the optical module 10, which is disposed at the subsequent stage of the optical amplifier of the OADM 1, drops the ASE light input from the optical amplifier and guides the dropped ASE light to the TF 12.

For example, the TF 12 generates a test signal for determining the connection state of the optical fiber by clipping an optical signal having a wavelength corresponding to a wavelength of the optical signal dropped by the OADM 1 from the ASE light input from the 1×2 CPL 11. The optical power of the test signal may be increased or decreased by the controller 7 or the like, based on the detection result of the PD 15.

At this time, the 2×1 SW 14 selects and outputs the input from the 1×2 CPL 13 (that is, the test signal) among the input from the 1×2 CPL 11 and the input from the 1×2 CPL 13 (step S12). At the time of actually operating the optical system and the OADM 1, the 2×1 SW 14 selects and outputs the input from the 1×2 CPL 11 (that is, the main signal light) among the input from the 1×2 CPL 11 and the input from the 1×2 CPL 13.

Herein, the determining method of the present example will be described by exemplifying a case where the optical module 10 is disposed between the optical amplifier, which amplifies the optical signal input from the west route among the optical amplifiers of the optical module 2-1, and the 1×n SPL of the optical module 3-1.

In this case, the test signal, which is generated and output by the optical module 10, is input to the optical module 3-1 through the optical fiber that connects the optical module 10 and the optical module 3-1.

After being dropped by the 1×n SPL of the optical module 3-1, the test signal is dropped by the SPL of the optical module 3-1 and is input to the optical module 4 through the optical fiber that connects the optical module 3-1 and the optical module 4.

At this time, the controller 7 determines whether or not the test signal is detected at a certain level at the optical detector (drop side PD) disposed at the receiving terminal of the optical amplifier disposed at the preceding stage of the SPL of the optical module 4 (step S13). The level refers to the optical power of the test signal, the gain of which is controlled by the PD 15 of the optical module 10 and the controller 7.

In a case where the test signal is detected at the certain level at the drop side PD (Yes route of step S13), the controller 7 determines that at least the optical fiber propagating the test signal among optical fiber connections between the optical module 3-1 and the optical module 4 is correctly connected.

On the other hand, in a case where the test signal is not detected at the certain level at the drop side PD (No route of step S13), the controller 7 determines that at least the optical fiber propagating the test signal among optical fiber connections between the optical module 3-1 and the optical module 4 is incorrectly connected, and notifies a network manager or the like of the incorrect connection of the optical fiber or the disconnection of the optical fiber (step S14). Therefore, the incorrect connection of the optical fiber or the disconnection of the optical fiber can be corrected by a network administrator or a user.

The controller 7 may determine that the optical fiber is incorrectly connected in a case where the detection result of the optical power of the test signal is less than a certain threshold value, and may determine that the optical fiber is correctly connected in a case where the detection result of the optical power of the test signal is equal to or greater than the certain threshold value.

When at least the optical fiber propagating the test signal among the optical fiber connections between the optical module 3-1 and the optical module 4 is correctly connected, the controller 7 determines whether or not the test signal is detected at a certain level by the optical detector (PD) disposed at the receiving terminal of the OXC of the optical module 5-1 (step S15).

In a case where the test signal is detected at the certain level by the optical detector (PD) disposed at the receiving terminal of the OXC of the optical module 5-1 (Yes route of step S15), the controller 7 determines that at least the optical fiber propagating the test signal among the optical fiber connections between the optical module 4 and the optical module 5-1 is correctly connected.

On the other hand, in a case where the test signal is not detected at the certain level by the optical detector (PD) disposed at the receiving terminal of the OXC of the optical module 5-1 (No route of step S15), the controller 7 determines that at least the optical fiber propagating the test signal among the optical fiber connections between the optical module 4 and the optical module 5-1 is incorrectly connected and notifies the network manager or the like of the incorrect connection of the optical fiber or the disconnection of the optical fiber (step S16). Therefore, the incorrect connection of the optical fiber or the disconnection of the optical fiber can be corrected by the network administrator or the user.

The controller 7 may determine that the optical fiber is incorrectly connected in a case where the detection result of the optical power of the test signal is less than a certain threshold value, and may determine that the optical fiber is correctly connected in a case where the detection result of the optical power of the test signal is equal to or greater than the certain threshold value.

When at least the optical fiber propagating the test signal among the optical fiber connections between the optical module 4 and the optical module 5-1 is correctly connected, the controller 7 determines whether or not the test signal is detected at the certain level by the optical detector (PD) disposed at the receiving terminal of the TP of the optical module 6-1 (step S17).

In a case where the test signal is detected at the certain level by the optical detector (PD) disposed at the receiving terminal of the TP of the optical module 6-1 (Yes route of step S17), the controller 7 determines that at least the optical fiber propagating the test signal among the optical fiber connections between the optical module 5-1 and the optical module 6-1 is correctly connected. Also, in this case, it may be confirmed that a transparent wavelength setting of the TF of the optical module 5-1 is valid.

On the other hand, in a case where the test signal is not detected at the certain level by the optical detector (PD) disposed at the receiving terminal of the TP of the optical module 6-1 (No route of step S17), the controller 7 determines that at least the optical fiber propagating the test signal among the optical fiber connections between the optical module 5-1 and the optical module 6-1 is incorrectly connected and notifies the network manager or the like of the incorrect connection of the optical fiber or the disconnection of the optical fiber (step S18). Therefore, the incorrect connection of the optical fiber or the disconnection of the optical fiber can be corrected by the network administrator or the user.

The controller 7 may determine that the optical fiber is incorrectly connected in a case where the detection result of the optical power of the test signal is less than a certain threshold value, and may determine that the optical fiber is correctly connected in a case where the detection result of the optical power of the test signal is equal to or greater than the certain threshold value.

As described above, when the validity of the connections of the respective optical fibers propagating the test signal is guaranteed, the controller 7 changes the transparent wavelength of the TF 12 (step S19) and repeats steps S13 to S18 described above. For example, the controller 7 changes the transparent wavelength of the TF 12 such that the other wavelength of the optical signal dropped by the OADM 1 is passed.

Therefore, it is possible to verify and guarantee the validity of the connections of the other optical fibers among the optical modules 3-1, 4, 5-1, and 6-1. When the validity of the connections of all optical fibers among the optical modules 3-1, 4, 5-1, and 6-1 is guaranteed, the controller 7 may end the optical fiber determining process. In a case where there is a connection portion, of which the validity of the optical fiber connection is confirmed, a part of the process of determining the connection state of the optical fiber corresponding to the relevant connection portion may be omitted.

In the above-described example, the optical module 10 is disposed between the optical amplifier, which amplifies the optical signal input from the west route among the optical amplifiers of the optical module 2-1, and the 1×n SPL of the optical module 3-1, and the validity of the connections of the respective optical fibers in the drop direction among the optical modules 3-1, 4, 5-1, and 6-1 is determined. For example, when the optical module 10 is disposed between the optical amplifier, which amplifies the optical signal input from the east route among the optical amplifiers of the optical module 2-2, and the 1×n SPL of the optical module 3-2, the validity of the connections of the respective optical fibers in the drop direction among the optical modules 3-2, 4, 5-1, and 6-1 can also be determined in a similar manner.

Also, when the optical module 10 is disposed between the optical amplifier of the optical module 4 and the CPL of the optical module 3-1 (or 3-2), the validity of the connections of the respective optical fibers in the add direction among the optical modules 4 and 3-1 (or 3-2) can also be determined in a similar manner.

As described above, according to the present example, it is possible to easily determine the connection state of the optical fiber.

[2] First Modification

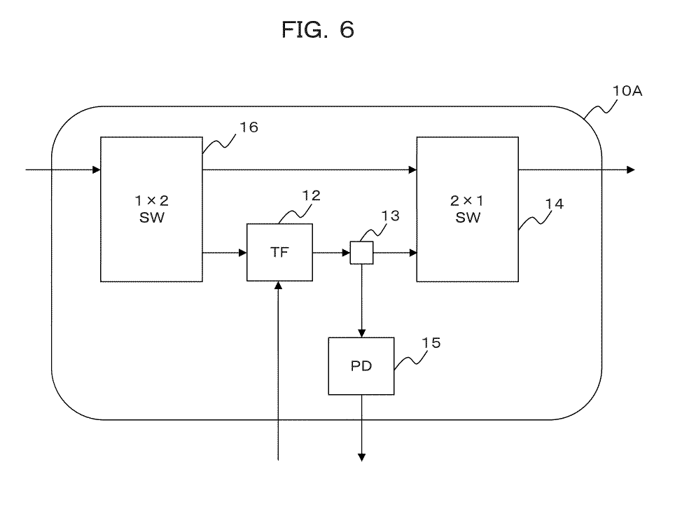

Alternatively, an optical module 10A illustrated in FIG. 6 may be used.

The optical module 10A includes a 1×2 SW 16 instead of the 1×2 CPL 11. In FIG. 6, the elements assigned with the same reference numerals as those of FIG. 3 have the same functions as the elements illustrated in FIG. 3, and thus, a description thereof will be omitted.

The 1×2 SW 16 selectively outputs the optical signal input from the input port through any one output port. For example, the 1×2 SW 16 outputs the input light to the route of the TF 12 at the time of determining the connection state of the optical fiber when the OADM 1 is started up or a new channel is established, and outputs the input light to the 2×1 SW 14 at the time of actually operating the optical system and the OADM 1. The selecting operation of the 1×2 SW 16 may be controlled by, for example, the controller 7 or the like.

By using the optical module 10A instead of the optical module 10, it is possible to obtain the same effect as the above embodiment and reduce the loss of the main signal light.

[3] Second Modification

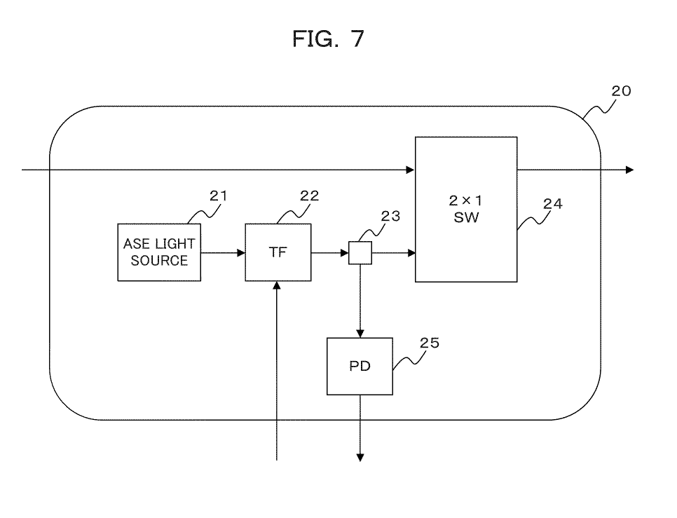

Alternatively, an optical module 20 illustrated in FIG. 7 may be used.

The optical module 20 illustrated in FIG. 7 includes, for example, an ASE light source 21, a TF 22, a 1×2 CPL 23, a 2×1 SW 24, and a PD 25.

The ASE light source 21 outputs ASE light illustrated in FIG. 4A.

The TF 22 passes only an optical signal having a certain wavelength and blocks optical signals having the other wavelengths in the ASE light input from the ASE light source 21. The wavelength passed by the TF 22 may be controlled by, for example, the controller 7 or the like.

For example, in the process of determining the connection state of the optical fiber, ASE light having a frequency-optical power characteristic illustrated in FIG. 4A is input to the TF 22. In this case, as illustrated in FIG. 4B, the TF 22 generates a test signal for determining the connection state of the optical fiber by clipping a portion of ASE light corresponding to an optical signal, which propagates through the optical system, having a single wavelength. The test signal, which is generated by the TF 22, is output to the 1×2 CPL 23.

The 1×2 CPL 23 drops the test signal generated by the TF 22 and guides the dropped test signal to the 2×1 SW 24 and the PD 25.

The 2×1 SW 24 selects one of the optical signal input from the outside and the optical signal input from the 1×2 CPL 23 and outputs the selected optical signal. For example, the 2×1 SW 24 selects the optical signal input from the 1×2 CPL 23 (that is, the test signal) at the time of determining the connection state of the optical fiber when the OADM 1 is started up or a new channel is established, and selects the optical signal input from the outside (that is, the main signal light) at the time of actually operating the optical system and the OADM 1. The selecting operation of the 2×1 SW 24 may be controlled by, for example, the controller 7 or the like.

Also, the PD 25 detects the optical power of the test signal that is dropped and input by the 1×2 CPL 23. The detection result, for example, is notified to the controller 7 or the like and is used in an amplification gain control for the optical amplifier of the OADM 1, a pass band control of the TF 22, or the like. That is, the optical power of the test signal may be controlled to a certain value.

When the optical module 20 configured as above is disposed at, for example, the preceding stage of the TP of the optical module 6-2, the validity of the connections of the respective optical fibers in the add direction among the optical modules 6-2, 5-2, 4, and 3-1 (or 3-2) can also be determined in a similar manner.

[4] Third Modification

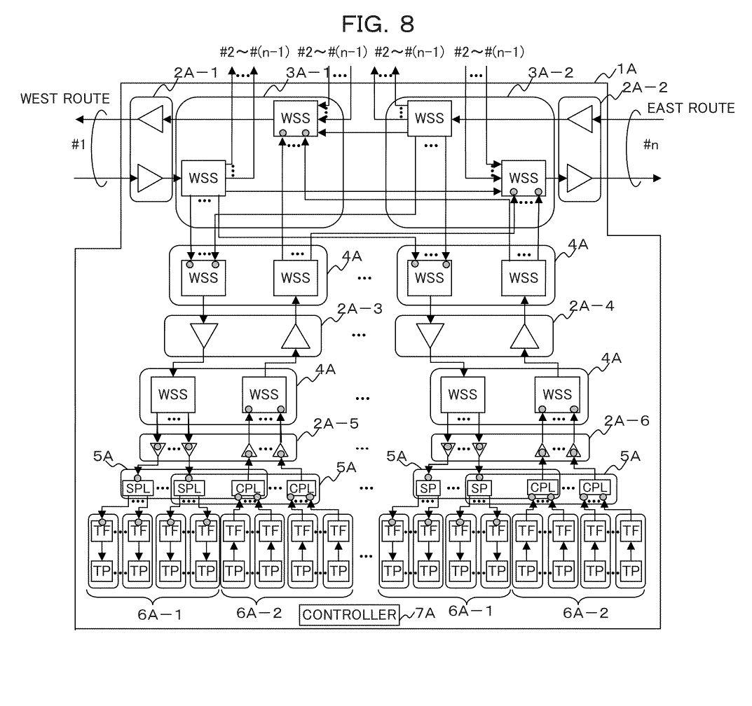

FIG. 8 is a diagram that illustrates an example of a configuration of an OADM 1A according to a third modification.

The OADM 1A illustrated in FIG. 8 includes, for example, optical modules (packages) 2A-1 to 2A-6, 3A-1, 3A-2, 4A, 5A, 6A-1, and 6A-2, each of which corresponds to a functional block including a plurality of optical devices (optical elements), and a controller 7A that controls the respective optical modules 2A-1 to 2A-6, 3A-1, 3A-2, 4A, 5A, 6A-1, and 6A-2.

Also, as in the embodiments and the respective modifications described above, optical detectors (PD) capable of detecting optical power of input light are disposed at receiving terminals (connection destinations of the optical fibers) of the respective optical modules 2A-1 to 2A-6, 3A-1, 3A-2, 4A, 5A, 6A-1, and 6A-2 of the OADM 1A (see a shaded circle in FIG. 8).

In the OADM 1A illustrated in FIG. 8, when at least one of the above-described optical modules 10, 10A, and 20 is disposed at an appropriate position, the validity of the connections of the respective optical fibers among the optical modules 2A-1 to 2A-6, 3A-1, 3A-2, 4A, 5A, 6A-1, and 6A-2 can be easily determined.

Also, a setting error of a wavelength selection in each WSS or an abnormal operation such as failure of each WSS itself can also be determined.

[5] Fourth Modification

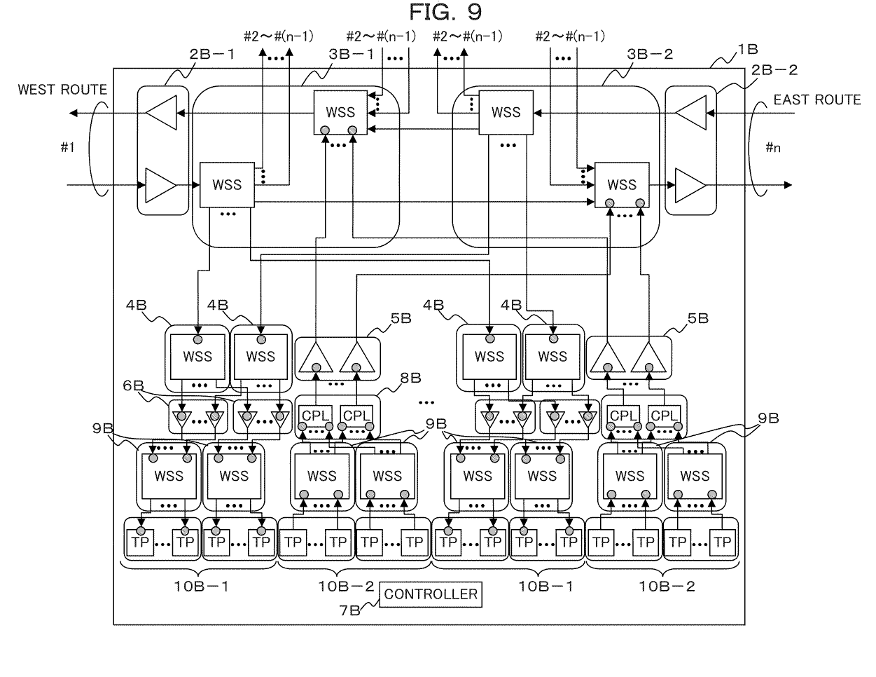

FIG. 9 is a diagram that illustrates an example of a configuration of an OADM 1B according to a fourth modification.

The OADM 1B illustrated in FIG. 9 includes, for example, optical modules (packages) 2B-1, 2B-2, 3B-1, 3B-2, 4B, 5B, 6B, 8B, 9B, 10B-1, and 10B-2, each of which corresponds to a functional block including a plurality of optical devices (optical elements), and a controller 7B that controls the respective optical modules 2B-1, 2B-2, 3B-1, 3B-2, 4B, 5B, 6B, 8B, 9B, 10B-1, and 10B-2.

Also, as in the embodiments and the respective modifications described above, optical detectors (PD) capable of detecting optical power of input light are disposed at receiving terminals (connection destinations of the optical fibers) of the respective optical modules 2B-1, 2B-2, 3B-1, 3B-2, 4B, 5B, 6B, 8B, 9B, 10B-1, and 10B-2 of the OADM 1B (see a shaded circle in FIG. 9).

In the OADM 1B illustrated in FIG. 9, when at least one of the above-described optical modules 10, 10A, and 20 is disposed at an appropriate position, the validity of the connections of the respective optical fibers among the optical modules 2B-1, 2B-2, 3B-1, 3B-2, 4B, 5B, 6B, 8B, 9B, 10B-1, and 10B-2 can be easily determined.

Also, a setting error of a wavelength selection in each WSS or an abnormal operation such as failure of each WSS itself can also be determined.

[6] Fifth Modification

Alternatively, the validity of the connections of the optical fibers and the route setting of the respective optical signals can be determined by modulating the test signal and detecting the power level of the test signal and the modulation frequency in combination. Even in a case where an optical signal having a wavelength different from a wavelength of an optical signal capable of being received at the receiving terminal is input, the connection state of the optical fiber can be determined based on the modulation frequency of the modulation performed on the input light.

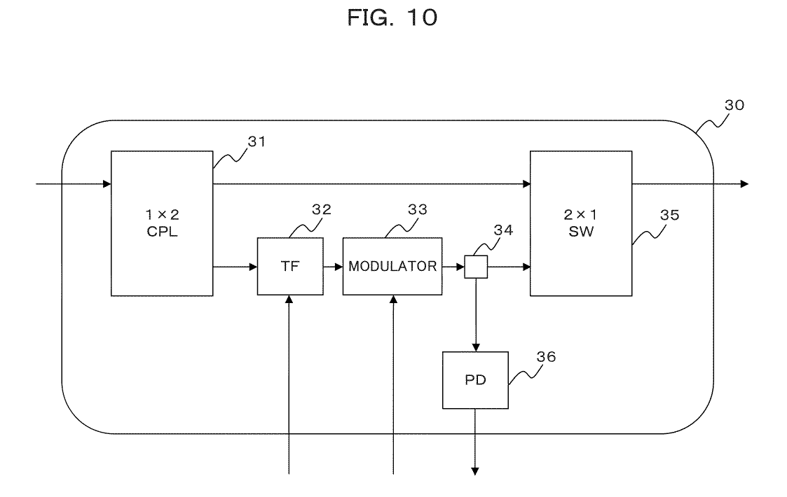

FIG. 10 is a diagram that illustrates an example of a configuration of the optical module according to the fifth modification.

The optical module 30 illustrated in FIG. 10 includes, for example, a 1×2 CPL 31, a TF 32, a modulator 33, a 1×2 CPL 34, a 2×1 SW 35, and a PD 36.

Herein, the 1×2 CPL 31 drops input light and guides the dropped input light to the 2×1 SW 35 and the TF 32 of the subsequent stage. The input light includes ASE light input from the optical amplifier or the like of the preceding stage and main signal light input during the operation of the optical system.

The TF 32 passes only an optical signal having a certain wavelength and blocks optical signals having the other wavelengths, among optical signals input from the 1×2 CPL 31. The wavelength passed by the TF 32 may be controlled by, for example, the controller 7 or the like.

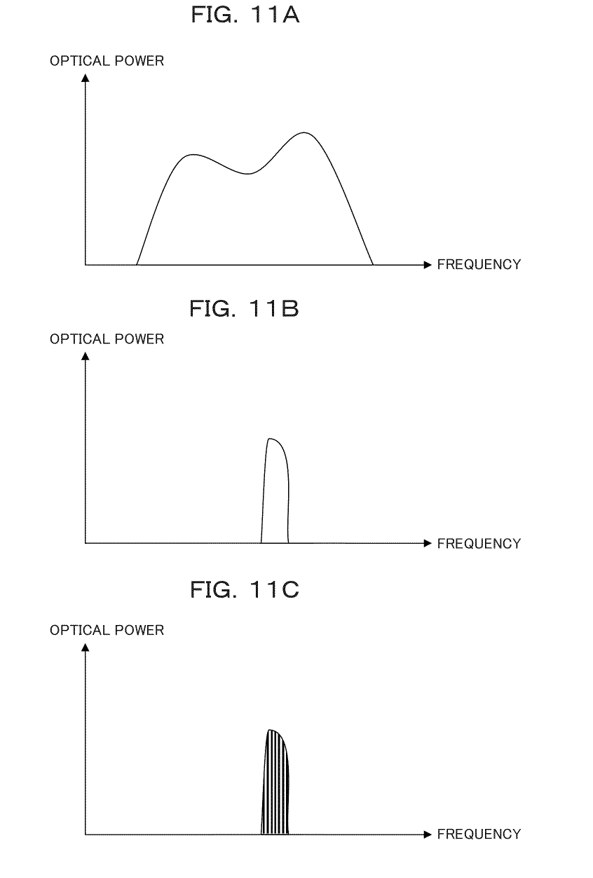

For example, in the process of determining the connection state of the optical fiber, ASE light having a frequency-optical power characteristic illustrated in FIG. 11A is input to the TF 32. In this case, as illustrated in FIG. 11B, the TF 32 clips ASE light corresponding to an optical signal, which propagates through the optical system, having a single wavelength. The optical signal, which is clipped by the TF 32, is output to the modulator 33.

The modulator 33 performs modulation on the optical signal clipped by the TF 32 in a certain modulation frequency. The modulation frequency of the modulation performed by the modulator 33 may be controlled by, for example, the controller 7 or the like. In the modulator 33, for example, a ferroelectric crystal such as lithium niobate (LiNbO₃) may be used.

For example, in the process of determining the connection state of the optical fiber, the optical signal illustrated in FIG. 11B is input to the modulator 33. In this case, as illustrated in FIG. 11C, the modulator 33 generates a test signal for determining the connection state of the optical fiber by performing the modulation on the input optical signal by using the certain modulation frequency. The test signal, which is generated by the modulator 33, is output to the 1×2 CPL 34.

The 1×2 CPL 34 drops the test signal generated by the TF 32 and the modulator 33 and guides the dropped test signal to the 2×1 SW 35 and the PD 36.

The 2×1 SW 35 selects one of the optical signal input from the 1×2 CPL 31 and the optical signal input from the 1×2 CPL 34 and outputs the selected optical signal. For example, the 2×1 SW 35 selects the optical signal input from the 1×2 CPL 34 (that is, the test signal) at the time of determining the connection state of the optical fiber when the OADM 1 is started up or a new channel is established, and selects the optical signal input from the 1×2 CPL 31 (that is, the main signal light) at the time of actually operating the optical system and the OADM 1. The selecting operation of the 2×1 SW 35 may be controlled by, for example, the controller 7 or the like.

Also, the PD 36 detects the modulation frequency and the optical power of the test signal that is dropped and input by the 1×2 CPL 34. The detection result, for example, is notified to the controller 7 or the like and is used in an amplification gain control for the optical amplifier of the OADM 1, a pass band control of the TF 32, a modulation frequency control of the modulator 33, or the like. That is, the modulation frequency and the optical power of the test signal may be controlled to certain values, respectively.

The test signal, which is generated by the optical module 30 having the above configuration, is detected at the optical detectors (PD) provided at the optical fiber connection terminals of the respective optical modules 2 to 6 and whether or not the respective optical fiber connections are valid is determined based on the detection result.

For example, the controller 7 determines that the optical fiber is correctly connected in a case where the detection result of the modulation frequency of the test signal is matched with the certain modulation frequency and the detection result of the optical power of the test signal is equal to or greater than a certain threshold value, and determines that the optical fiber is incorrectly connected in a case where the detection result of the modulation frequency of the test signal is not matched with the certain modulation frequency and in a case where the detection result of the optical power of the test signal is less than the certain threshold value.

Also, for example, in the OADM 1 illustrated in FIG. 2, even when the optical module 30 is disposed between the optical amplifier of the optical module 2-1 and the 1×n SPL of the optical module 3-1 and the optical module 30 is disposed between the optical amplifier of the optical module 2-2 and the 1×n SPL of the optical module 3-2, if modulation frequencies in the respective modulators 33 are set to different values, the respective PDs can identify from which optical module 30 the test signal is transmitted, and thus, the validity of the route setting of the respective optical signals can also be easily determined.

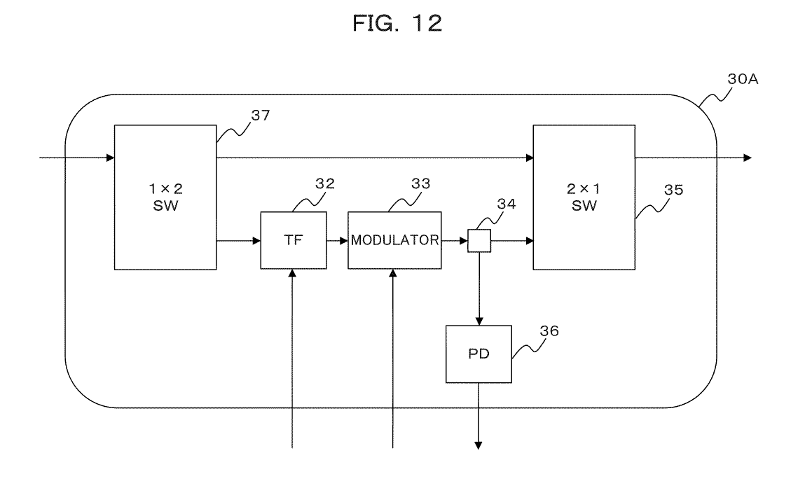

Alternatively, in the present example, an optical module 30A illustrated in FIG. 12 may be used.

The optical module 30A includes a 1×2 SW 37 instead of the 1×2 CPL 31. In FIG. 12, the elements assigned with the same reference numerals as those of FIG. 10 have the same functions as the elements illustrated in FIG. 10, and thus, a description thereof will be omitted.

The 1×2 SW 37 selectively outputs the optical signal input from the input port through any one output port. For example, the 1×2 SW 37 outputs the input light to the route of the TF 32 at the time of determining the connection state of the optical fiber when the OADM 1 is started up or a new channel is established, and outputs the input light to the 2×1 SW 35 at the time of actually operating the optical system and the OADM 1. The selecting operation of the 1×2 SW 37 may be controlled by, for example, the controller 7 or the like.

By using the optical module 30A, it is possible to obtain the same effect as described above and reduce the loss of the main signal light.

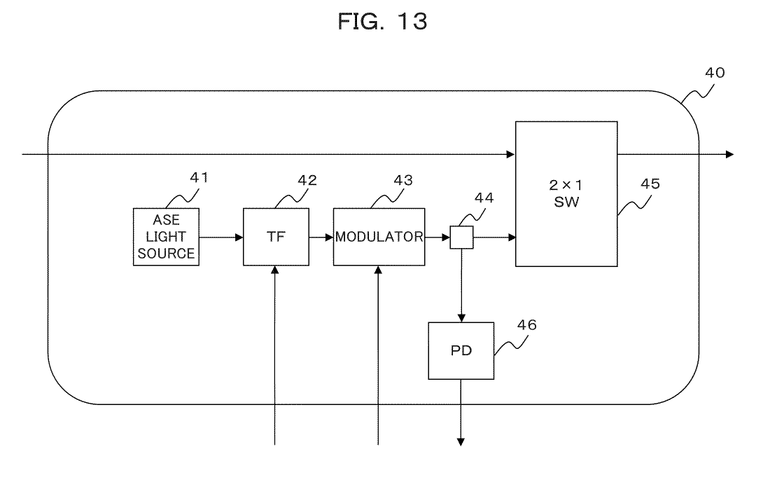

Furthermore, in the present example, an optical module 40 illustrated in FIG. 13 may be used.

The optical module 40 illustrated in FIG. 13 includes, for example, an ASE light source 41, a TF 42, a modulator 43, a 1×2 CPL 44, a 2×1 SW 45, and a PD 46.

The ASE light source 41 outputs ASE light illustrated in FIG. 11A.

The TF 42 passes only an optical signal having a certain wavelength and blocks optical signals having the other wavelengths in the ASE light input from the ASE light source 41. The wavelength passed by the TF 42 may be controlled by, for example, the controller 7 or the like.

For example, in the process of determining the connection state of the optical fiber, ASE light having a frequency-optical power characteristic illustrated in FIG. 11A is input to the TF 42. In this case, as illustrated in FIG. 11B, the TF 42 clips a portion of ASE light corresponding to an optical signal, which propagates through the optical system, having a single wavelength. The optical signal, which is clipped by the TF 42, is output to the modulator 43.

The modulator 43 performs modulation on the optical signal clipped by the TF 42 in a certain modulation frequency. The modulation frequency of the modulation performed by the modulator 43 may be controlled by, for example, the controller 7 or the like. In the modulator 43, for example, a ferroelectric crystal such as lithium niobate (LiNbO₃) may be used.

For example, in the process of determining the connection state of the optical fiber, the optical signal illustrated in FIG. 11B is input to the modulator 43. In this case, as illustrated in FIG. 11C, the modulator 43 generates a test signal for determining the connection state of the optical fiber by performing the modulation on the input optical signal by using a certain modulation frequency. The test signal, which is generated by the modulator 43, is output to the 1×2 CPL 44.

The 1×2 CPL 44 drops the test signal generated by the TF 42 and the modulator 43 and guides the dropped test signal to the 2×1 SW 45 and the PD 46.

The 2×1 SW 45 selects one of the optical signal input from the outside and the optical signal input from the 1×2 CPL 44 and outputs the selected optical signal. For example, the 2×1 SW 45 selects the optical signal input from the 1×2 CPL 44 (that is, the test signal) at the time of determining the connection state of the optical fiber when the OADM 1 is started up or a new channel is established, and selects the optical signal input from the outside (that is, the main signal light) at the time of actually operating the optical system and the OADM 1. The selecting operation of the 2×1 SW 45 may be controlled by, for example, the controller 7 or the like.

Also, the PD 46 detects the modulation frequency and the optical power of the test signal that is dropped and input by the 1×2 CPL 44. The detection result, for example, is notified to the controller 7 or the like and is used in an amplification gain control for the optical amplifier of the OADM 1, a pass band control of the TF 42, a modulation frequency control of the modulator 43, or the like. That is, the modulation frequency and the optical power of the test signal may be controlled to certain values, respectively.

When the optical module 40 configured as above is disposed at, for example, the preceding stage of the TP of the optical module 6-2, the validity of the connections of the respective optical fibers in the add direction among the optical modules 6-2, 5-2, 4, and 3-1 (or 3-2) can also be determined in a similar manner.

Also, for example, in the OADM 1 illustrated in FIG. 2, even when the optical modules 40 are disposed at the preceding stages of the TPs of the respective optical modules 6-2, if modulation frequencies in the respective modulators 43 are set to different values, the respective PDs can identify from which optical module 40 the test signal is transmitted, and thus, the validity of the route setting of the respective optical signals can also be easily determined.

[7] Sixth Modification

Alternatively, the TFs 12, 22, 32, and 42 of the respective optical modules 10, 10A, 20, 30, 30A, and 40 arbitrarily change the bandwidth of the test signal clipped from the ASE light. By using this characteristic, a pseudo signal (test signal) corresponding to a high-speed (in other words, broadband) optical signal of, for example, 400 Gbps, 1 Tbps, or the like can be generated.

In the present example, by using the test signal, it is possible to easily determine the validity of the operation states of the respective optical devices (optical modules) prior to the actual signal input.

For example, in the OADM 1B illustrated in FIG. 9, the optical module 10 is disposed between the optical amplifier, which amplifies the optical signal input from the west route, among the optical amplifiers of the optical module 2B-1, and the WSS of the optical module 3B-1.

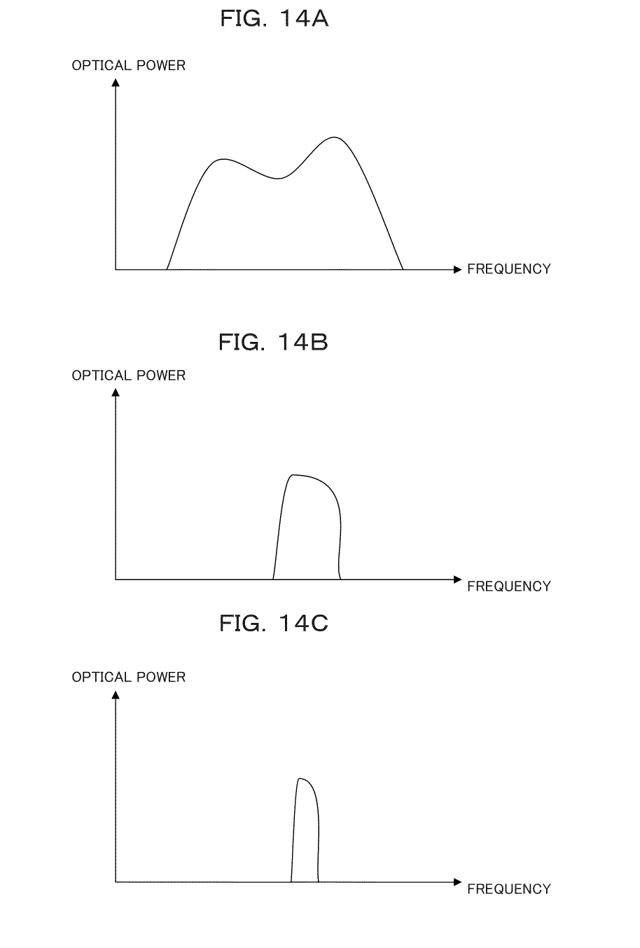

As illustrated in FIG. 14B, the optical module 10 generates the pseudo signal (test signal) corresponding to the high-speed (in other words, broadband) optical signal of 400 Gbps, 1 Tbps, or the like by clipping a portion of the ASE light illustrated in FIG. 14A.

Then, the PDs of the respective optical modules 4B, 6B, 9B, and 10B-1 detect the optical power of the test signal generated by the optical module 10.

Herein, in any one of the optical modules 4B, 6B, 9B, and 10B-1, when there is a setting error related to a wavelength band, the test signal input to each PD has a waveform illustrated in FIG. 14C.

Therefore, in a case where the optical power detected at each PD is lower than a certain level, it is determined that there is an incorrect connection in the optical fiber that connects the respective optical modules 4B, 6B, 9B, and 10B-1, or is determined that there is a setting error related to a wavelength band in the respective optical modules 4B, 6B, 9B, and 10B-1.

By using the determining methods according to the above-described embodiments and the respective modifications, the validity of the connection of the optical fiber that connects the respective optical modules 4B, 6B, 9B, and 10B-1 can be guaranteed. By using the method according to the present example, it can be easily determined that there is the setting error related to the wavelength band in the respective optical modules 4B, 6B, 9B, and 10B-1 in a case where the optical power detected at each PD is lower than the certain level.

[8] Others

In the above-described embodiments, the respective configurations and functions of the optical modules 10, 10A, 20, 30, 30A, and 40 and the OADMs 1, 1A, and 1B may be selected as needed and may be used appropriately combined. That is, the above-described configurations and functions may be selected as needed and may be appropriately combined so as to fulfill the function of the present disclosure.

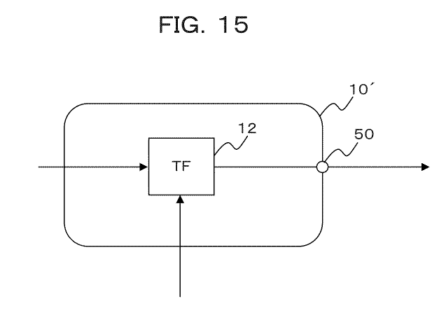

For example, in the above-described example, the system operation can be performed while the optical modules 10, 10A, 20, 30, 30A, and 40 is interposed between the optical module 2-1 and the optical module 3-1, but an optical module 10′ having a configuration illustrated in FIG. 15 may be interposed between the optical module 2-1 and the optical module 3-1 only in the process of determining the connection state of the optical fiber. In this case, as illustrated in FIG. 15, the optical module 10′ may include a TF 12 that generates a test signal having a wavelength corresponding to a wavelength of an optical signal capable of being received at one receiving terminal among a plurality of receiving terminals by clipping a portion of the input ASE light, and an output port 50 that outputs the test signal generated by the TF 12.

Also, in the above-described examples, one of the controllers 7, 7A, and 7B functions as an example of a processor that determines the connection state of the optical fiber based on the detection result of each PD, but the optical modules 10, 10A, 20, 30, 30A, and 40 may separately include the same processor.

It is possible to easily determine the connection state of the optical fiber.

All examples and conditional language provided herein are intended for pedagogical purposes of aiding the reader in understanding the invention and the concepts contributed by the inventor to furthering the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. A determining method for determining a connection state of an optical fiber that connects a transmitting terminal and a plurality of receiving terminals, the determining method comprising:
generating a test signal having a wavelength corresponding to a wavelength of an optical signal capable of being received at one receiving terminal among the plurality of receiving terminals by clipping a portion of amplified spontaneous emission light;
transmitting the generated test signal through the optical fiber;
detecting optical power of the test signal at the one receiving terminal; and
determining the connection state of the optical fiber based on a detection result of the optical power of the test signal.

2. The determining method according to claim 1, wherein
determining that the optical fiber is incorrectly connected in a case where the detection result of the optical power of the test signal is less than a certain threshold value, and
determining that the optical fiber is correctly connected in a case where the detection result of the optical power of the test signal is equal to or greater than the certain threshold value.

3. The determining method according to claim 1, further comprising:
modulating the test signal in a certain modulation frequency before the test signal is transmitted through the optical fiber;
detecting the optical power and the modulation frequency of the test signal at a receiving terminal to which the optical fiber is connected among the plurality of receiving terminals; and
determining the connection state of the optical fiber based on detection results of the optical power and the modulation frequency of the test signal.

4. The determining method according to claim 3, wherein
determining that the optical fiber is correctly connected in a case where the detection result of the modulation frequency of the test signal is matched with the certain modulation frequency and the detection result of the optical power of the test signal is equal to or greater than a certain threshold value, and
determining that the optical fiber is incorrectly connected in a case where the detection result of the modulation frequency of the test signal is not matched with the certain modulation frequency and in a case where the detection result of the optical power of the test signal is less than the certain threshold value.

5. A determining optical module for determining a connection state of an optical fiber that connects a transmitting terminal and a plurality of receiving terminals, the determining optical module comprising:
a wavelength tunable filter configured to generate a test signal having a wavelength corresponding to a wavelength of an optical signal capable of being received at one receiving terminal among the plurality of receiving terminals by clipping a portion of amplified spontaneous emission light; and
an optical output interface configured to output the test signal generated by the wavelength tunable filter.

6. The determining optical module according to claim 5, further comprising a light source configured to supply the spontaneous emission light to the wavelength tunable filter.

7. The determining optical module according to claim 5, further comprising a modulator provided between the wavelength tunable filter and the optical output interface and configured to modulate the test signal in a certain modulation frequency.

8. An optical communication apparatus comprising:
a plurality of optical modules;
an optical fiber configured to connect the plurality of optical modules;
the determining optical module according to claim 5;
a photo detector configured to detect the optical power of the test signal output from the determining optical module at the one receiving terminal; and
a processor configured to determine the connection state of the optical fiber based on a detection result of the photo detector.

9. The optical communication apparatus according to claim 8, wherein
the processor is configured to determine that the optical fiber is incorrectly connected in a case where the detection result of the optical power of the test signal is less than a certain threshold value, and
the processor is configured to determine that the optical fiber is correctly connected in a case where the detection result of the optical power of the test signal is equal to or greater than a certain threshold value.

10. The optical communication apparatus according to claim 8, wherein the processor is configured
to detect the optical power and a modulation frequency of the test signal at a receiving terminal to which the optical fiber is connected among the plurality of receiving terminals, and
to determine the connection state of the optical fiber based on the detection results of the optical power and the modulation frequency of the test signal.
